(19) United States
(12) Patent Application Publication
(10) Pub. No.: US 2012/0021828 A1
(43) Pub. Date: Jan. 26, 2012

(54) GRAPHICAL USER INTERFACE FOR MODIFICATION OF ANIMATION DATA USING PRESET ANIMATION SAMPLES

(75) Inventors: Bay Leaf Raitt, Carnation, WA (US); Joseph Eddy Demers, Seattle, WA (US); Yahn William Bernier, Seattle, WA (US); Brian Ratcliff Jacobson, Seattle, WA (US); Marc Sean Scaparro, Bellevue, WA (US); Karl Ian Whinnie, Issaquah, WA (US)

(73) Assignee: Valve Corporation, Bellevue, WA (US)

(21) Appl. No.: 13/034,650

(22) Filed: Feb. 24, 2011

Related U.S. Application Data
(60) Provisional application No. 61/308,070, filed on Feb. 25, 2010.
(60) Provisional application No. 61/307,781, filed on Feb. 24, 2010.

(51) Int. Cl. A63F 13/00

(52) U.S. Cl. 463/31

(57) ABSTRACT

Embodiments are directed to recording and editing of multi-dimensional video game world data obtained from execution of a video game sequence. An animation editor records the video game world data within a plurality of data logs after execution of an animation component of the video game and prior to providing the data to a material system and/or graphics device for rendering. The user may edit the recorded data to make changes in the recorded game sequence, by employing an animation preset. The user selects an animation preset and combines the preset with a target animation over a time interval. A filter or mask may be used to selectively alter portions of a character or a frame. The animation preset may be selectively stretched or compressed based on the time interval of the target animation and the length of the animation preset.

This application is a utility patent application based on U.S. Provisional Patent Application Ser. No. 61/307,781, filed on Feb. 24, 2010, the benefit of which is hereby claimed under 35 U.S.C. §119(e), and is related to U.S. Provisional Patent Application Ser. No. 61/308,070, filed Feb. 25, 2010. Both Provisional patent applications in their entirety are incorporated by reference herein.

### FIELD OF THE INVENTION

The present disclosure relates to virtual environment systems, and in particular, but not exclusively, to a system and method for employing animation preset samples with multi-dimensional video game world data using an animation editor.

### BACKGROUND

Motion capture is a mechanism often used in the movie recording industry for recording movement and translating the movement onto a digital model. In particular, in the movie industry, motion capture involves recording of actions of human actors and using that recorded information to animate a digital character model in 3-dimensional (3D) animation.

In a typical motion capture session, an actor may wear recording devices, sometimes called markers, at various locations on their body. A computing device may then record motion from changes in a position or angle between the markers. Acoustic, inertial, LED, magnetic and/or reflective markers may be used to obtain the changes. This recorded data may then be mapped to a 3D animation model so that the model may then perform the same actions as that of the actor. Often, camera movements can also be motion captured so that a virtual camera in the scene may pan, tilt, or perform other actions, to enable the animation model to have a same perspective as the video images from the camera.

While motion capture does provide rapid or even real time results, motion capture also has several disadvantages. For example, motion capture often requires reshooting of a scene when problems occur. Moreover, because live actors are used, movements that might not follow the laws of physics generally cannot be motion captured. Moreover, where the computer model has different proportions to that of the actor, the captured data might result in unacceptable artifacts due to recording intersections of data, or the like. Therefore, it is with respect to these considerations and others that the present invention has been made.

### BRIEF DESCRIPTION OF THE DRAWINGS

Non-limiting and non-exhaustive embodiments of the present invention are described in reference to the following drawings. In the drawings, like reference numerals refer to like parts through all the various figures unless otherwise explicit.

For a better understanding of the present disclosure, a reference will be made to the following detailed description, which is to be read in association with the accompanying drawings, wherein:

FIG. 1 is a block diagram of one embodiment of a system in which the present invention may be employed;

FIG. 2 is a block diagram of one embodiment of a network device that may be used for recording and/or editing of multi-dimensional video game world data;

FIG. 3 is a block diagram illustrating one embodiment of a relationship between various components within the network device of FIG. 2 that are useable for at least capturing a plurality of components of a video game world within a recorded video game sequence, modifying at least some of the captured components, and feeding the modifications into the video game and/or a material system for use in modifying a display of the video game sequence;

FIG. 4 is one embodiment of non-limiting, non-exhaustive examples of a plurality of components of a video game world;

FIG. 5 is a non-limiting example of one embodiment of a video game display illustrating a recording sequence of one joint component;

FIG. 6 is a flow diagram illustrating one embodiment of an overview of a process useable for recording and editing multi-dimensional video game world data;

FIG. 7 is a block diagram of an animation development system that may be used in accordance with an embodiment of the present disclosure;

FIG. 8 illustrates an example of preset data that may be used in accordance with an embodiment of the present disclosure;

FIG. 9 illustrates an example of an animation segment that may be used in accordance with an embodiment of the present disclosure;

FIG. 10 illustrates an example of an animation segment subsequent to insertion of preset data, in accordance with an embodiment of the present disclosure;

FIG. 11 illustrates a mechanism for inserting an animation preset into a target animation sequence, in accordance with an embodiment of the present disclosure;

FIG. 12 is an example of an interface for editing an animation, in accordance with an embodiment of the present disclosure;

FIG. 13 is a flow diagram illustrating a process of generating an animation preset in accordance with an embodiment of the present disclosure; and

FIG. 14 is a flow diagram illustrating a process of applying a preset to an animation in accordance with an embodiment of the present disclosure.

### DETAILED DESCRIPTION

The present disclosure will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

As used herein, the term “motion capture” refers to a process of recording movement of a live actor, and translating that movement into a digital model. A used herein, the term “animation motion capture” refers to a process of recording movement and other components of a video game world for later use in re-computing a game state for playing and/or editing. Thus, animation motion capture is directed at overcoming at least some of the disadvantages of live motion capture involving a live actor, including, for example, being constrained by the laws of physics, an inability to modify a viewer's perspective of the video game world during a ‘playback,’ as well as other constraints that are discussed further below.

As used herein, the term “character” refers to an object or a portion of an object that has multiple visual representations in an animation or animation frame. Examples of characters include a person, animal, hair of a character, an object such as a weapon held by a person, clothes various anthropomorphized objects, or the like. A character has a visual representation on a computer display device. However, a character may have other representations, such as numeric, geometric, or a mathematical representation.

As used herein, the term “feature” of a character refers to the character or a component thereof. A character may include one or more features. A feature has a visual representation. It may have other representations, such as a numeric, geometric, or mathematical representation.

As used herein, the term “behavior” refers to action or a state of a character or feature, the behavior of the character or feature having one or more visual representations. A behavior may correspond to one or more characters, but not necessarily all characters. Examples of behavior-character pairs include smile-face-Joe, frown-face-Joe, running-legs-John, windy-hair-Mary, windy-clothes, angry-tree, or the like, where each behavior refers to a specific character. Thus, smile-face-Joe is distinct from smile-face-Mary. A facial expression of a character is one type of character behavior. Facial expressions are used herein to illustrate mechanisms that may be applied to character behaviors. A behavior may have a range and the range may be measured by a value that represents magnitude of the behavior. For example, a smile may have a magnitude ranging from zero to 1.0, though other ranges may also be used. References to a behavior herein may be considered to be references to the representation of the behavior. As for character and feature, a behavior may have non-visual representations, such as numeric, geometric, or mathematical representations. For example, a character's smile may be represented by data that includes a length of the character's lips.

As used herein, the term “game,” or “video game” refers to an interactive sequence of images played back in time with audio to create a non-linear activity for the player. As used herein, the term “movie” refers to a fixed sequence of images played back in time with audio to create a linear narrative experience.

As used herein, the term “sequence” refers to a subset of a movie, that includes shots. Further, a sequence may be associated with a particular level.

As used herein, the term “level” refers to a virtual world as experience by a player of the game, usually including, for example, puzzles or objectives. A level may be composed of 3D representations of a sky, ground, ocean, buildings, plants, characters, sounds, or the like.

As used herein, the term “shot” refers to a subset of a sequence. Each shot includes a minimum of a time duration and a camera to view a game world. A shot further includes all the components in a scene, including, for example, characters, motions, and the like, as described further below. As used herein, the term “clip” refers to a shot.

As used herein, the term “time selection” refers to a duration of time. In one embodiment, the user may select a range of time within a shot over which to apply a modification of recorded animation. In one embodiment, a user can make an irregular motion, smooth by selecting the time selection and applying a smoothing operation. A time selection may also have fade in and fade out regions before and after the specified time selection to help create smooth transitions to/from the effected time region. This is referred to herein as time selection falloff.

As used herein, the term “animation” refers to a sequence of data that describes change over time of one or more images. The animation may be stored in a set of data formats within a plurality of distinct data logs such as Booleans (for components of the animation such as visibility, events, particles, or the like); integers (for components of the animation such as texture assignments or the like); floats (for components of the animation, such as light brightness or the like); vectors (for components of the animation, such as colors of the like); or quaternions (for transforms, or the like). Each data has a corresponding time that is then used to create a corresponding visual representation by evaluating the data at that time stamp and connecting various display components, such as those described further below.

As used herein, the terms “log” or “data log” refer to a collection of time value pairs used to store animation data. As described further below, the animation data is stored in a plurality of distinct data logs, such that a data log may correspond to a given frame within the animation.

As used herein, the term “frame” refers to a single visual representation of an image within a sequence of images. Thus, in one embodiment, an animation is represented by a sequence of frames.

As an example, then, a movie includes sequences. The sequence includes shots, which in turn includes frames. A frame then may be made by combining the game world data and, if available, any recorded data, which in turn is fed into a material system and associated hardware for display to a user.

Briefly stated, the present disclosure is directed towards providing an integrated video game and editing system for recording multi-dimensional video game world data that may be subsequently edited and fed back into a video game for modifying a display of a video game sequence. In one embodiment, a video game editor may be used to enable an animator to use preset samples in modifying the recorded multi-dimensional video game world data.

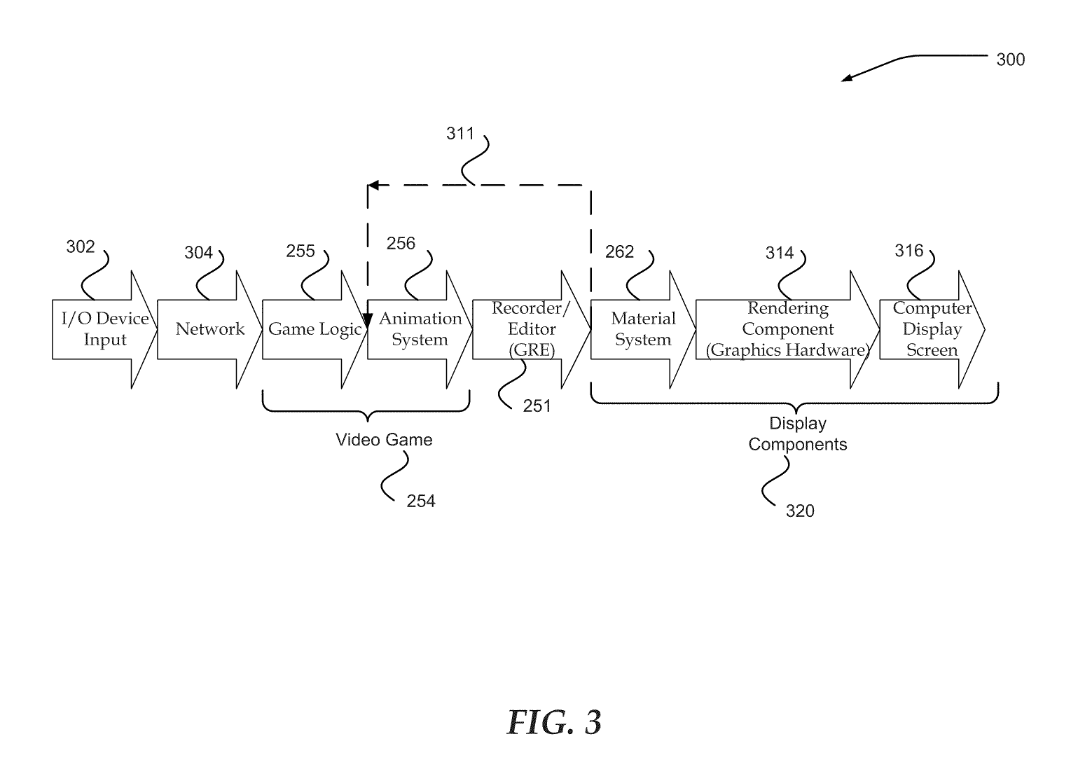

The multi-dimensional video game world data is recorded at a sufficiently early stage (or upstream of lower level rendering and output primitives) during execution of a video game such that a plurality of multi-dimensional video game world data components are recorded and made available for later editing. In one embodiment, the recording of the game world data is obtained from output of an animation system component of the video game, as described in more detail below in conjunction with FIG. 3.

In one embodiment, the recorded multi-dimensional video game world data represents a plurality of components of the game world such as motion data, state data, logical and/or physical physics data including collision data, events, character data, or the like. The recorded multi-dimensional video game world data however, might not be directly useable to render an animated image for display. Instead, the recorded multi-dimensional video game world data is arranged to be fed into a material system that is configured to perform such pre-rendering activities such as occlusion analysis, lighting, shading, and other actions upon the output from the video game. The output of the material system may then be rendered for display of a video game image or images (e.g., sequence). In one embodiment, the rendering may be performed using a graphics hardware card or other component of a computing device. By collecting the data used to compute the images rather than the images themselves, or the rendered data of the image, or even inputs to the video game, an editor (e.g., user) is afforded greater flexibility in manipulating or otherwise editing a video game play sequence. Based upon this, the data used to compute the images may be modified using the herein disclosed game recorder/editor (GRE).

In traditional filmmaking, video sequences are based on a sequence of two-dimensional images, such as video clips. When a filmmaker wants to change the image(s) within a video clip, often a regeneration of the video clip is required. That is, a live action filmmaker might have to re-assemble staff, equipment, actors, or the like, to recapture the image(s). For animated movies, the animators would have to start over again, as well, by replaying, modifying, rendering, and then re-recording the video sequence of images. In traditional animated movies, and/or live action filmmaking, the process of re-doing a video sequence can be expensive.

Unlike traditional approaches, the disclosed integrated video game and editing system fundamentally shifts the foundation of filmmaking away from two-dimensional video clips, and instead records data for a plurality of multi-dimensional video game world components that may then be fed back into the video game for use in computing data useable for a downstream rendering component to render the video sequence for display on a computer display device. Using the multi-dimensional video game world data, an editor may readily add characters, change animations, move camera perspectives, and the like, for a video sequence, without having to completely recreate the video sequence. Such approaches would not be feasible, for example, where the recorded sequence represents a streamed video sequence of images, or even data used by a rendering component to render the video sequence. Moreover, by recording the data used to compute the images rather than the images themselves, the GRE enables a user to modify a larger variety of details of a video game sequence. Additionally, in one embodiment, such modifications may be fed back into the video game to result in new computations of a video game sequence, thereby taking advantage of the animation system.

In one embodiment, the GRE may further include a development subsystem and editing subsystem. The development subsystem may be used to generate one or more animation presets that are to be used in subsequent animation editing. The editing subsystem may receive one or more animation presets, provide an interface that enables an animator to specify a preset and a way of integrating the preset with the animation that is composed of recorded multi-dimensional video game world data, and automatically apply the preset to generate one or more frames of an animation that subsequently modifies the resultant visual display. The preset may be transitioned into the animation over a time interval.

Additionally, there may be anchored and non-anchored presets. When an anchored preset is applied, it is relative to the joint/control/value that was marked as the anchor, and then applies itself normally. For example, if there is a “step left foot forward” preset whose anchor was the right foot of a video game character, and it was applied to a standing character, that character's entire body would move forwards into the left foot forward pose such that the right foot remained stationary. In comparison, applying a non-anchored preset would cause the character's body to remain in place, while his left foot moved forward and his right foot moved back.

In one aspect of the invention, the GRE may receive a specification of an animation preset including a sequence of frames, retrieve the animation preset, receive a specification of a subsequence of the animation, and copy at least a portion of the animation preset to the animation. A specification of a filter or mask delineating a portion of a frame may be used to determine the portion of the animation preset that is copied.

In one aspect of the invention, a sub-sequence may include a target character and a portion of the target character less than the complete target character may be replaced by a portion of the animation preset.

In one aspect of the invention, a time length of the animation preset may be different from a time length of the sub-sequence. The animation preset may be compressed or stretched to fit the time length of the sub-sequence.

In one aspect of the invention, the development subsystem of the GRE may record a sequence of frames during play of an animated game. Additional data may be recorded during another play of the animated game, and combined with the recorded sequence of frames to generate an animation preset.

Although the disclosures discussed herein are focused on animations and more particularly on video games, those skilled in the art will appreciate that the systems, devices, and methods described may be output to create other media content, such as comic books, posters, movies, marketing materials, or combination of film and animation, or other applications to generate toys, without departing from the spirit of the disclosure. Moreover, the input may be from virtually any multi-dimensional input, such as simulation systems, architectural visualizations, or the like. Furthermore, the functionality of the invention may also be employed with a non-video game world system, that could include motion capture data and manual animation of characters, objects, events, and the like, for other types of applications e.g., movies, television, webcasts, and the like.

### Illustrative Operating Environment

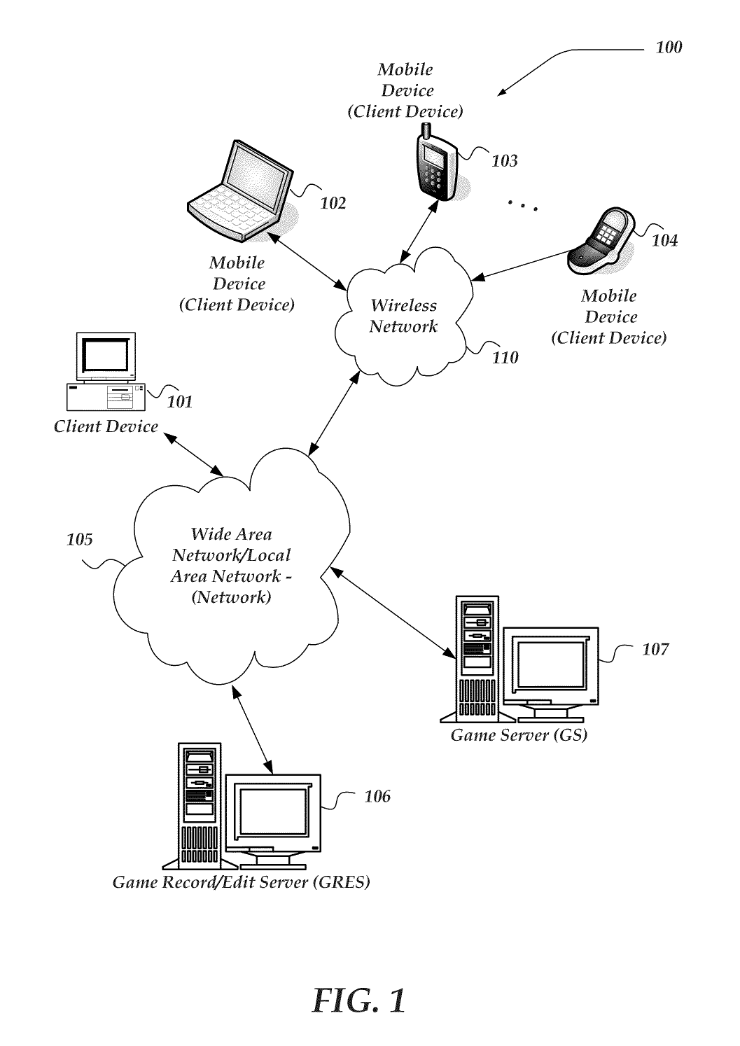

FIG. 1 illustrates a block diagram generally showing an overview of one embodiment of a system in which the present invention may be practiced. System 100 may include many more components than those shown in FIG. 1. However, the components shown are sufficient to disclose an illustrative embodiment for practicing the present invention. As shown in the figure, system 100 includes local area networks (“LANs”)/wide area networks (“WANs”)-(network) 105, wireless network 110, client devices 101-104, Game Record/Edit Server (GRES) 106, and game server (GS) 107.

Client devices 102-104 may include virtually any mobile computing device capable of receiving and sending a message over a network, such as network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information. For example, in one embodiment, the browser may be employed to access and/or play a video game accessible over one or more networks from GS 107 and/or GRES 106.

Client devices 101-104 also may include at least one other client application that is configured to receive content from another computing device. The client application may include a capability to provide and receive textual content, multimedia information, components to a computer application, such as a video game, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to enable a user to request and/or otherwise obtain various computer applications, including, but not limited to video game applications, such as a video game client component, or the like. In one embodiment, the computer application may be obtained via a portable storage device such as a CD-ROM, a digital versatile disk (DVD), optical storage device, magnetic cassette, magnetic tape, magnetic disk storage, or the like. However, in another embodiment, client devices 101-104 may be enabled to request and/or otherwise obtain various computer applications over a network, from such as GRES 106 and/or GS 107, or the like.

Thus, for example, a user of client devices 101-104 might request and receive a computer game application, such as an online computer game, or the like. In one embodiment, the user may have the computer game execute a client management component on one of client devices 101-104 that may then be employed to communicate over network 105 (and/or wireless network 110) with GS 107, GRES 106, and/or other client devices, to enable the gaming experience.

In another embodiment, client devices 101-104 may also be configured to play a video game that is hosted remotely at one or more of GRES 106 and/or GS 107. In one embodiment, client devices 101-104 may further access a game recorder and/or game editor application that may be remotely hosted on GRES 106. Thus, a user of client devices 101-104 may configure a video game for play, and record one or more sequences of video game play using the game recorder. In one embodiment, the game recorder is configured to record multi-dimensional video game world data including, but not limited to a plurality of joints over time for one or more video game characters, objects held by the video game characters, or any of a variety of other video game objects, including trees, vehicles, and the like. The user may also record various data used to generate various background components of the video game sequence, including, but not limited to buildings, mountains, sounds, various environmental data, timing data, collision data, and the like. The user may then use the game editor to edit portions of the recorded multi-dimensional video game world data.

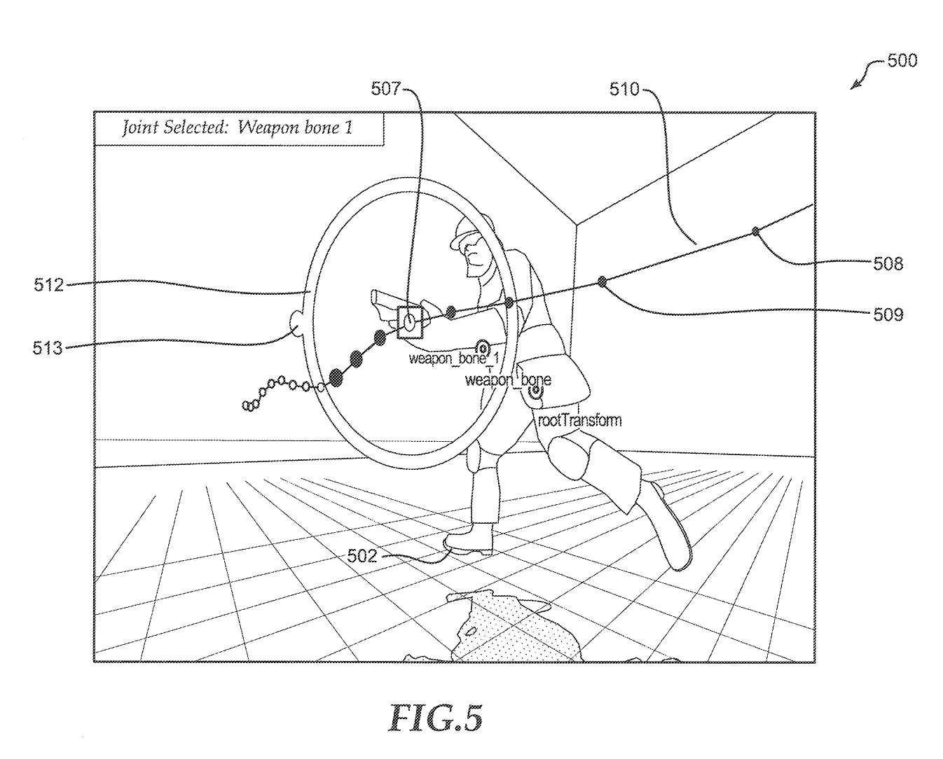

In one embodiment, the user may be provided with a user interface such as described below that is configured to enable the user to select various joints for display using a motion trail. As described further below, the motion trail represents positions, displayed as position indicators, within a computer video game sequence in which a joint may be located within a given frame within the sequence. An example of a motion trail with displayed position indicators is described in more detail in conjunction with FIG. 5 below.

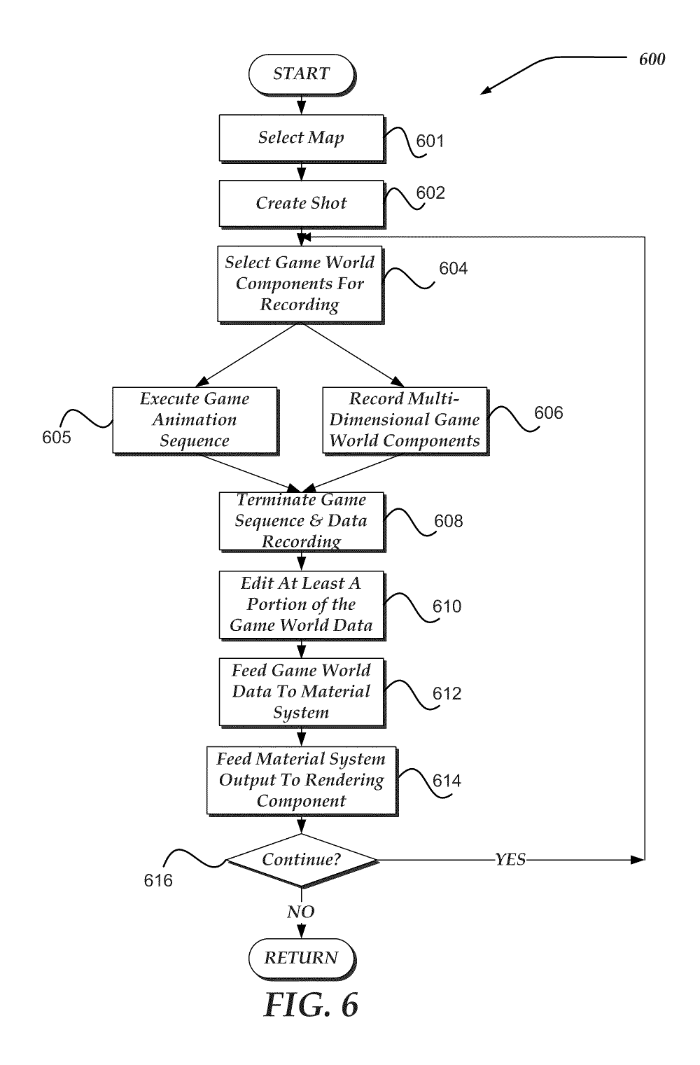

The user may modify the motion trail by replacing position indicators within the motion trail, deleting position indicators, adding new position indicators, and/or dragging position indicators to change a displayed location of the joint for one or more frames within the motion trail. By modifying the motion trail for one or more joints, the user may modify how an animated character within a game might be viewed. Moreover, in one embodiment, because multi-dimensional video game world data is recorded as that data used to compute a given image, rather than the video character image itself, the user may also change a viewing perspective of the animated scene, including the game character. For example, in a first execution and recording of the game, the user might display the game from a perspective of the game character. However, subsequent replaying and/or editing of the game based on the recorded multi-dimensional video game world data, the user may change the perspective to be watching the game character, in a third person perspective. In the third person perspective of the play of the recorded game based on the multi-dimensional video game world data, the user may select any of a variety of different views of the scene. Recording and editing of the recorded multi-dimensional video game world data is described in more detail below in conjunction with FIGS. 5-6.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple GRES 106, GS 107, and client device 101 with other computing devices, including potentially through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

GS 107 may include any computing device capable of connecting to network 105 to manage delivery of components of an application, such as a game application, or virtually any other digital content. In addition, GS 107 may also be configured to enable an end-user, such as an end-user of client devices 101-104, to selectively access, install, and/or execute the application, such as a video game.

GS 107 may further enable a user to participate in one or more online games. Moreover, GS 107 might interact with GRES 106 to enable a user of client devices 101-104 to record and/or edit state data from a video game execution. GS 107 might receive a registration of a user, and/or send the user a list of users and current presence information, such as a user name (or alias), an online/offline status, whether a user is in a game, which game a user is currently playing online, or the like, to client devices 101-104. In at least one embodiment, GS 107 might employ various messaging protocols to provide such information to a user. In one embodiment, GS 107 might further provide at least some of the information through a messaging session to one or more users. Thus, in one embodiment, GS 107 might be configured to receive and/or store various game data, user account information, game status and/or game state information, or the like.

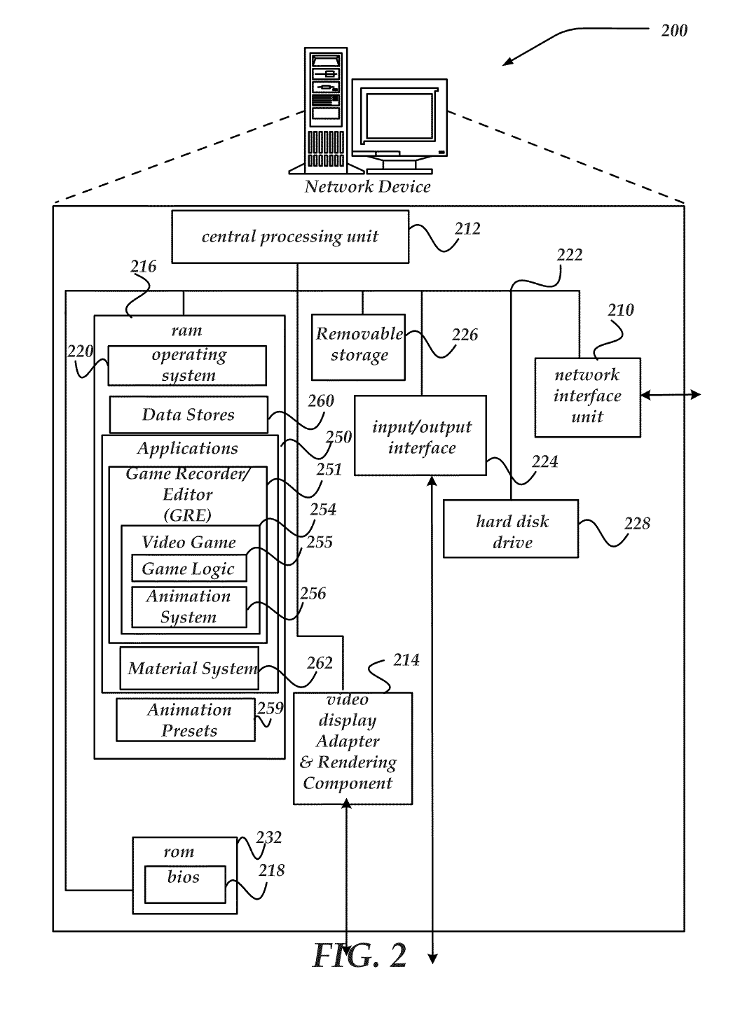

One embodiment of a network device useable for GRES 106 is described in more detail below in conjunction with FIG. 2. Briefly, however, GRES 106 includes virtually any network computing device that is configured to enable a user to record video game state data as multi-dimensional video game world data during an animation motion capture, and to edit such recorded video game data. In one embodiment, GRES 106 may be configured to receive the video game state data from GS 107. In another embodiment, however, GRES 106 may be configured to include a various video game components, such as described in more detail below in conjunction with FIG. 2 to generate and/or play a video game. GRES 106 may record the multi-dimensional video game world data using a flat data structure. However, in another embodiment, the multi-dimensional video game world data may be recorded using a tree structure, a mesh structure, or the like, based on various components of a character, background, and/or other components within the video game world. GRES 106 may further enable a user to edit portions of the multi-dimensional video game world data using process such as described below in conjunction with FIG. 6.

Devices that may operate as GRES 106 and/or GS 107 include personal computers, desktop computers, multiprocessor systems, microprocessor-based or programmable consumer electronics, network PCs, servers, and the like.

Moreover, although GRES 106 and/or GS 107 are described as distinct servers, the invention is not so limited. For example, one or more of the functions associated with these servers may be implemented in a single server, distributed across a peer-to-peer system structure, or the like, without departing from the scope or spirit of the invention. Therefore, the invention is not constrained or otherwise limited by the configuration shown in FIG. 1.

### Illustrative Network Device

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, GS 107 integrated into GRES 106 of FIG. 1.

Network device 200 includes processing unit 212, video display adapter & rendering component 214, and a mass memory, all in communication with each other via bus 222. The rendering component of video display adapter & rendering component 214 is configured to calculate effects in a video editing file to produce a final video output that may then be displayed on a video display screen. Video display adapter & rendering component 214 may use any of a variety of mechanisms in which to convert an input object into a digital image for display on the video display screen. Network device 200 also includes input/output interface 224 for communicating with external devices, such as a headset, or other input or output devices, including, but not limited, to joystick, mouse, keyboard, voice input system, touch screen input, or the like.

The mass memory generally includes RAM 216, ROM 232, and one or more permanent mass storage devices, such as hard disk drive 228, and removable storage device 226 that may represent a tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol, Wi-Fi, Zigbee, WCDMA, HSDPA, Bluetooth, WEDGE, EDGE, UMTS, or the like. Network interface unit 210 is sometimes known as a transceiver, transceiving device, or network interface card (NIC).

The mass memory as described above illustrates another type of computer-readable media, namely computer storage media. Computer-readable storage media may include volatile, nonvolatile, removable, and non-removable media implemented in any method or technology for storage of information, such as computer readable instructions, data structures, program modules, or other data. Examples of computer-readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. In one embodiment, the mass memory may include one or more applications 250 and one or more data stores 260. Data stores 260 include virtually any component that is configured and arranged to store data including, but not limited to user preference data, log-in data, user authentication data, game data, recorded and/or edited multi-dimensional video game world data, and the like. Data store 260 also includes virtually any component that is configured and arranged to store and manage digital content, such as computer applications, video games, and the like. As such, data stores 260 may be implemented using a database, a file, directory, or the like.

One or more applications 250 are loaded into mass memory and run on operating system 220 via central processing unit 212. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 250 may also include a Game Recorder/Editor (GRE) 251, and material system 262. As shown, in one embodiment, GRE 251 may include video game 254, which includes various components including, but not limited to game logic 255 and animation system 256.

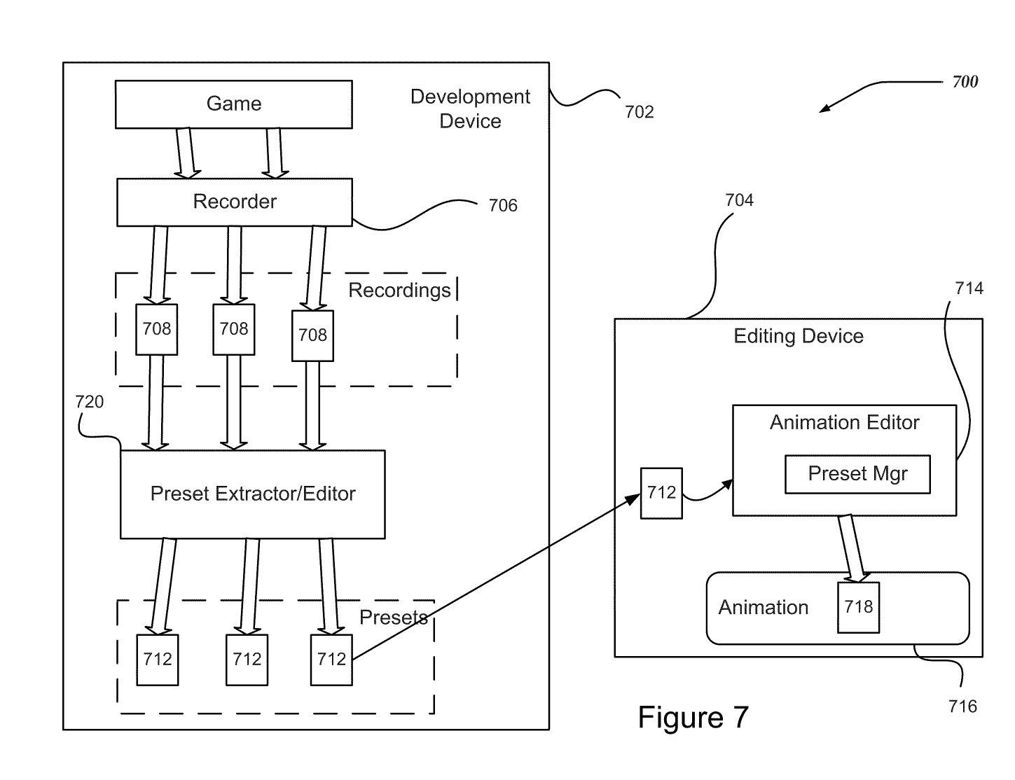

One embodiment of GRE 251 and video game 254 are described in more detail below in conjunction with FIGS. 3 and 7. Briefly, however, GRE 251 is configured to enable a user to capture video game data that may subsequently be manipulated (or edited). GRE 251 is configured to provide user interfaces that enable a user to select various aspects of a video game to record and/or edit using animation motion capture of multi-dimensional video game world data. As such GRE 251 may interact with video game 254 to enable the user to play a portion of an animated sequence for a game. The user might further interact with video game 254 to modify the animation sequence to be recorded. GRE 251 enables the user to identify what state information is to be recorded as multi-dimensional video game world data. For example, the user might select to record virtually every aspect of the animation sequence, including every joint of each character, or other object within the sequence, sounds, coloring, material and/or textual changes, flex weights (which specify a weighting to employ when blending various morph targets) related to changes in a joint, and/or a variety of other information.

GRE 251 may then record the identified state information while the animation sequence is played (executes). During execution of the sequence, the user may manipulate one or more characters and/or objects within the game. For example, in one non-limiting example, the user might select to operate in a first person perspective as one of the game characters, and control the movements of that game character during the recorded game sequence. In another embodiment, one or more other game characters may be controlled, and therefore perform movements based on instructions from video game 254, and/or from another, previously recorded animation sequence.

The user may then employ GRE 251 to replay the game sequence that was recorded using the multi-dimensional video game world data. In one embodiment, the user may select to view the recorded game sequence from any of a variety of camera perspectives other than from that of the game character. For example, the user may change camera perspective while the recorded game sequence is being replayed. In one embodiment, the user may record the change to the camera perspective during the recorded game sequence, allowing for subsequent playback to appear to use a different camera perspective.

GRE 251 further provides user interfaces to enable the user to edit the recorded game sequence using a variety of techniques. Because the game sequence is recorded using multi-dimensional video game world data obtained as the data used to compute an image, rather than the image itself, the user may make a variety of changes to the recorded game sequence. For example, the user might select to display a frame of the recorded game sequence using the multi-dimensional video game world data to recreate the display of the game. The user may further select for display one or more joints from a plurality of joints that were recorded during the execution of the game sequence. The user may then have overlaid onto the display a motion trail for the joint that represents positions in game space of the selected joint over time. In one embodiment, position indicators, such as circles, dots, or other symbols, may be used to indicate on the motion trail, the joint position in game space for each recorded frame. One non-limiting example of such a motion trail using position indicators is illustrated in FIG. 5.

The user may then employ GRE 251 to select some portion of the motion trail over time From within GRE 251, the user may further edit the motion trail, thereby changing the location of the joint in game space over time. For example, the user might select a position indicator on the motion trail, and drag the position indicator from a first position to a second position. In one embodiment, GRE 251 may smooth transitions between adjacent position indicators to the selected position indicator using a variety of mechanisms, including, but not limited to smoothing the transition between the underlying state data. For example, GRE 251 might automatically relocate adjacent position indicators based on a linear interpolation between position indicators on the motion trail. However, other mechanisms might also be used, including, but not limited to using a spike curve, a dome curve, a bell curve, ease in, ease out, ease in/out or the like, to smooth transitions between position indicators.

In one embodiment, GRE 251 automatically reflects the change in position by displaying in real-time, how the game character associated with the joint might appear in the second position. In one embodiment, the user may play, randomly access, or scrub forward or reverse, the selected sequence with the modification to view how the changed game sequence might now appear.

However, the invention is not limited to merely enabling the user to select and drag one or more position indicators on the motion trail. GRE 251 also enables the user to replace one or more portions of the motion trail with another game sequence, delete portions of the game sequence, insert other game sequences, or any of a variety of other game editing operations. For example, GRE 251 also enables a user to play a recorded game sequence using recorded multi-dimensional video game world data, and to composite one or more other characters onto the recorded game sequence during its execution. The composited game sequence may then be recorded using GRE 251 for subsequent editing using composited multi-dimensional video game world data.

Video game 254 is configured to manage execution of a video game for display at, for example, a client device, such as clients 101-104 of FIG. 1. In one embodiment, components of video game 254 may be provided to the client device over a network. In another embodiment, video game 254 may be configured to execute a video game on network device 200, such that a result of the execution of the video game may be displayed and/or edited at a client device.

Video game 254 includes game logic 255 and animation system 256. However, video game 254 may include more or less components than illustrated. In any event, video game 254 may receive, for example, input events from a game client, such as keys, mouse movements, and the like, and provide the input events to game logic 255. Video game 254 may also manage interrupts, user authentication, downloads, game start/pause/stop, or other video game actions. Video game 254 may also manage interactions between user inputs, game logic 255, and animation system 256. Video game 254 may also communicate with several game clients to enable multiple players, and the like. Video game 254 may also monitor actions associated with a game client, client device, another network device, and the like, to determine if the action is authorized. Video game 254 may also disable an input from an unauthorized sender.

Game logic 255 is configured to provide game rules, goals, and the like. Game logic 306 may include a definition of a game logic entity within the game, such as an avatar, vehicle, and the like. Game logic 255 may include rules, goals, and the like, associated with how the game logic character may move, interact, appear, and the like, as well. Game logic 255 may further include information about the environment, and the like, in which the game logic character may interact. Game logic 255 may also include a component associated with artificial intelligence, neural networks, and the like. As such, game logic 255 represents those processes by which the data found in multi-dimensional video game world data are evaluated to be at a correct state for a given moment of the video game world play, including which state should all the game world entities be in, which sound should be played, what score should a player have, what activities are the characters trying to act on, and the like.

Animation system 256 represents that portion of video game 254 that takes output of game logic 255 and poses animated elements in a state suitable for rendering. This includes moving character joints into a position to make it look like they are performing some action, or the like. As such, in one embodiment, animation system 256 may include a physics engine or subcomponent that is configured to provide mathematical computations for interactions, movements, forces, torques, flex weights, collision detections, collisions, and the like However, the invention is not so limited and virtually any physics subcomponent may be employed that is configured to determine properties of entities, and a relationship between the entities and environments related to the laws of physics as abstracted for a virtual environment. In any event, such computation data may be provided as output of animation system 256 for use by GRE 251 as portions of the plurality of multi-dimensional video game world data that may be recorded and/or modified.

In one embodiment, animation system 256 may include an audio subcomponent for generating audio files associated with position and distance of objects in a scene of the virtual environment. The audio subcomponent may further include a mixer for blending and cross fading channels of spatial sound data associated with objects and a character interacting in the scene. Such audio data may also be included within the plurality of multi-dimensional video game world data provided to GRE 251.

Material system 262 is configured to provide various material aspects to a video input, including, for example, determining a color for a given pixel of a rendered object, or the like. In one embodiment, material system 262 may employ various techniques to create a visual look of game world surfaces to be rendered. Such techniques include but are not limited to shading, texture mapping, bump mapping, shadowing, motion blur, illuminations, and the like.

Also illustrated in FIG. 2 are animation presets 259. Briefly, animations 256 represents preset data usable for modifying multi-dimensional video game world data including character behaviors, animations, and the like. Although illustrated as residing within ram 216, animation presets 259 may reside within data stores 260, and/or within removable storage 226, hard disk drive 228, and/or any of a variety of other computer-readable storage mediums, including within another network device.

### Non-Limiting Example of Data Flow within a Video Game System

FIG. 3 is a block diagram illustrating one embodiment of a relationship between various components within the network device of FIG. 2 that are used to capture a plurality of components of a video game world within a recorded video game sequence, modify at least some of the captured components, and to feed the modifications into the video game and/or a material system for use in modifying a display of the video game sequence. The components illustrated in system 300 of FIG. 3 may be implemented within GS 107 and/or GRES 106 of FIG. 1. It is noted that System 700, which is discussed further in conjunction with FIG. 7, provides another perspective of a relationship between various components of GRE 251 and video game 254 as useable to employ animation presets.

System 300 may include more or less components than those shown. The components shown, however, are sufficient to disclose an illustrative embodiment for practicing the invention. Moreover, while system 300 discloses one embodiment of distributing functions of a video game system across different components, the invention is not to be construed as so limited. Other distributions of functions across components may also be employed. For example, one or more components illustrated may be combined into a single component. Moreover, one or more components might not be employed. For example, network component 304 might not be employed in another embodiment.

However, as illustrated system 300 includes I/O device input 302, network 304, video game 254 that includes game logic 255 and animation system 256, GRE 251, material system 262, rendering component 314, and computer display screen 316, each of which are described in more detail above in conjunction with FIG. 2. For example, rendering component 314 represents the component of video display adapter & rendering component 214 of FIG. 2 that is useable to render an image to computer display screen 316. Similarly, I/O device input 302 represents one embodiment of input/output interface 224 of FIG. 2. Moreover, material system 262, rendering component 314 and computer display screen 316 may collectively be referred to a display components 320.

System 300 is intended to portray one embodiment of a flow of data through the various components for use in managing a video game play. That is, as shown, a user might employ various input devices, such as those described above, to input into various motions, actions, and the like for use by video game 254. For example, in one embodiment, the user might move a mouse; enter data through a keyboard, touch screen, voice system, or the like; move a joystick; or any of a variety of other devices useable to manipulate a game state within a video game sequence. The input from the user is provided through I/O device input 302 over network 304 to video game 254. In one embodiment, such user input may affect various states within the video game, resulting in updates by game logic 255. Game logic 255 provides updates to the video game world state to animation system 256 which in turn is used to pose various characters based on the modified game logic output. As shown, GRE 251 may intercept output from the animation system that includes data for a plurality of multi-dimensional video game world components, including data used to compute a character image. By intercepting the data used to compute the character image rather than the image itself, GRE 251 provides a user more flexibility over traditional approaches in modifying a game state sequence.

Output from GRE 251 may be fed back into video game 254, as shown by feedback 311, for revising the image data as represented by the plurality of multi-dimensional video game world component data. Output from GRE 251 may also be provided to material system 262 where coloring, shading, and other texturing actions may be performed on the data. The output of material system 262 may then be provided to the rendering component 314 to render the data into an image for display by computer display screen 316.

While GRE 251 is illustrated as capturing output from animation system 256, the invention is not so limited, and GRE 251 may also capture data from other components as well, including, but not limited to I/O device input 302, and/or game logic 255.

Data flow through system 300 may be further described using as a non-limiting, non-exhaustive example, of a “first person shooter” type of game. In this game example, then, while watching computer display screen 316, a user plays the first person shooter game using I/O device input 302 to provide inputs to the game. The user's inputs are then sent through network 304 to game logic, 255, which decides if the player hit a target within the game or not. Animation system 256 may then pose a skeleton of a game character, triggers the gunshot sound and starts a particle system within animation system 256. All this information, including outputs from animation system 256 is then recorded by the GRE 251 before being passed to material system 262. Material system 262 upon receiving the data from animation system 256 prepares the scene for the rendering component 314 by adding lights, textures, shaders, and the like, to the scene. All this data is then output back to computer screen 316 for the user to decide whether to shoot again, and/or to perform some other action using I/O device input 302.

After the recording has stopped, the entire experience can be replayed, in one embodiment, by replacing the user's I/O device input 302, network 304 data, and game logic 255 data with the recorded data as fed back using flow 311. Although the experience is now a playback of an GRE recording, it remains representative of the original experience since the data is fed back to the same display systems as the original experience (e.g., components 262, 314 and 316).

### Multi-Dimensional Video Game World Components

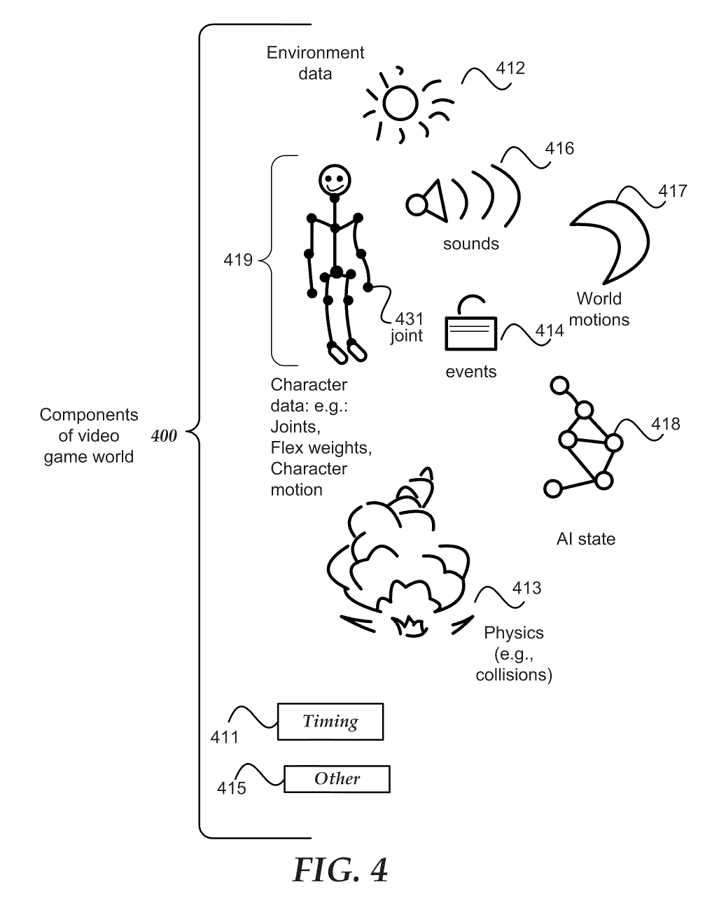

FIG. 4 is one embodiment of non-limiting, non-exhaustive examples of a plurality of components of a video game world for which a plurality of multi-dimensional video game world data may be obtained. Components 400 may include many more components than those shown. The components shown, however, are sufficient to disclose an illustrative embodiment for practicing the invention.

Components 400 represents various components of game state data that may be obtained during animation motion capture. The recorded multi-dimensional video game world data typically is received from one or more components of a video game during execution of an animated motion sequence. In one embodiment, the multi-dimensional video game world data obtained for components 400 includes one or more sets of data such as polygonal mesh data, joint hierarchies, material settings, AI state, particle system data, sound effects, sound triggers, camera placements, and/or virtually any game world state data employable to generate a virtual game world experience. Thus, the components illustrated are not to be construed as limiting, and others may also be used.

In any event, components 400 includes, timing data 411, material/textual changes 412, physics state data 413, visibility data 414, sound data 416, motion data 417, collision data 418, joint data 419, flex weight data 420, and other data 415 associated with the recorded game sequence. The other data 415 may include, but is not limited to wireframe/skeleton data, positional information, motion curve data, or the like. Virtually any data about the game scene over time may be recorded. As such, unlike merely recording triggers and events over time of a game sequence, components 400 represents a dense capture of multi-dimensional video game world data, in the sense that a large amount of details about a single component may be collected.

Thus, the multi-dimensional video game world data includes not only audio-visual aspects of the scene, but also other information such as wireframe/skeleton of characters and objects, positional information, game states, motion curves and characteristics, object visibility status, start/stop timing of sounds, material changes, state of material, material texture, particle information, physics information, context, and timestamp data, among others.

Besides the data used for creating the images and sounds that are captured, other data dimensions representing game state information such as motion, collision information, wireframe/skeleton data, timestamps, z-order of objects, and other such information may also be captured or extracted and stored for creating the new scene shot in a compositing cycle. The game state information generally includes information about objects and sounds included in the scene, and additionally, information about the scene itself that relate to all objects within the scene, such as scene location and time information.

Thus, such multi-dimensional video game world data enables a comprehensive and relatively easy and quick manipulation of objects and characters in the scene using the disclosed animation editor. Moreover, the captured data represented by components 400 may be stored in a file on a computer file system, or alternatively on an external computer-readable medium such as optical disks. In one embodiment, the multi-dimensional video game world data represented by components 400 may be initially recorded in a plurality of distinct data logs and then transferred and/or manipulated into another format, structure, or the like.

In one embodiment, components 400 may be implemented in a flat file format such that state data for each frame in the animated game sequence may be separately recorded. That is, the state data for any given frame is complete and independent of another set of state data from any other recorded frame. As such, a scene within the recorded game sequence may be fully recreated from the recorded state data for that frame. In one embodiment, multi-dimensional video game world data for each distinct frame may be stored in a distinct or different data log.

### Non-Limiting Video Game Motion Trail

FIG. 5 is a non-limiting, non-exhaustive example of one embodiment of a video game display illustrating a recording sequence for one joint over time using a motion trail. Display 500 may include many more components than those shown. The components shown, however, are sufficient to disclose an illustrative embodiment for practicing the invention.

As shown, game character 502 may be illustrated within a given scene, including backgrounds, and the like. In one embodiment, display 500 may represent a single frame from the recorded game sequence, recreated from the recorded multi-dimensional video game world data.

Further illustrated is motion trail 510 for a selected joint 507. As seen, motion trail includes a plurality of position indicators, such as 507-509 indicating a location within game space of the selected joint 507 over time. In one embodiment, the motion trail 510 may represent changes of the selected joint 507 over the entire recorded game sequence, each change being recorded as multi-dimensional video game world data within a distinct data log for a given frame. However, in another embodiment, motion trail 510 may be a selected subset (e.g., a “time selection”) of the recorded positions of selected joint 507. Motion trail 510 may be drawn onto display 500 to provide the user with a visual cue of transitions between position indicators. Computing motion trail 510 through the recorded positions of joint 507 as represented by the position indicators may be performed using virtually any mechanism.

As further shown, a user may be provided with a selector tool, such as selector ring 512. The user may employ selector ring 512 to select a range of position indicators to manipulate, zoom in/out on, or the like. In one embodiment, selector ring 512 may include a pivot handle 513 useable to rotate, drag, or otherwise further manipulate one or more enclosed position indicators. For example, in one embodiment, selector ring 512 may be centered onto position indicator 507, as shown by the rectangle over position indicator 507. The user may then employ pivot handle 513 to drag position indicator 507 from a first location to a second location, thereby modifying the displayed motion trail 510. As used herein, a “pivot” refers to a point around which a joint may rotate. By default, in one embodiment, the pivot or pivot point is the joint itself, but it can be moved to accommodate more complex rotations.

Thus, as illustrated, a user may select a specified frame based on a selected position indicator 507-509 within a recorded plurality of frames from within the recorded video game sequence that is stored within the plurality of distinct data logs. The user may then edit the sequence using the data log editor and such as described above, to edit at least some of the recorded multi-dimensional video game world data within at least one of the distinct data logs for a specified frame range. The user may then send the results to a material system and/or fed back the results of the editing to the animation system, and/or game logic components of the video game system to have the modified sequence displayed for the at least the specified frame range.

It should be noted, however, that the user is not limited to dragging position indicators within a motion trail. For example, the user may also select to delete position indicators, add position indicators, insert within a motion sequence into the recorded game sequence, or the like. Additionally, different types of manipulation may be selected by the user for the motion trail, including: (1) Replacement—an animation is replaced by a non-animated state such as a pose; (2) Transform—an animation is globally modified where the motion trail is shifted without changing the shape of the motion trail; and (3) Offset—an animation that is locally modified and where the motion trail is modified relative to itself.

### Generalized Operation

The operation of certain aspects of the invention will now be described with respect to FIG. 6. FIG. 6 is a flow diagram illustrating one embodiment of an overview of a process useable for recording and editing multi-dimensional video game world data. Process 600 of FIG. 6 may be implemented within network device 200 of FIG. 2, in one embodiment.

Process 600 begins, after a start block, at block 601 where a user selects a given map or video game to be played, including a game environment, such as a game scene, and one or more video game characters to be placed within the game scene for executing of a game sequence. Proceeding to block 602, the user may then select or otherwise create a given video sequence to be shot. In one embodiment, the given video sequence may be a subset of the given map selected within block 601. In at least another embodiment, each shot may be created with a separate map, and game world component data can be recorded multiple times into the same shot. Continuing to block 604, the user may further select one or more joints for recording as multi-dimensional video game world component data. That is, in one embodiment, the user identifies a plurality of components to be recorded with the video game world of block 601, where each component within the plurality is to be recorded within a distinct frame by frame data log to generate a plurality of different data logs.

In one embodiment, a default configuration may include recording of every joint within the game scene and/or on the game character. Such joints may be predefined during creation of the game character. For example, joints may be defined as pivot points between two ‘hands” of a skeleton structure. However, joints may also be defined by other desirable recording points on an animated structure. For example, for a leg, the joint points might include a knee control, but not be limited to the clothing, shoelaces, hemlines of a skirt, kneepads, or the like. For a vehicle, the joint points might include, but not be limited to several points along a radial arm of a tire, such as an outside point and/or a center point of a tire. Clearly, other joints may be identified than these examples illustrate, and thus the invention is not to be construed as being limited by such examples.

In any event, in one embodiment, the game character may be controlled by the user. That is, the user may provide various inputs using a mouse, keyboard, audio input, a joystick, or the like, to control movement of the game character. Movement of the game character is anticipated in resulting in movement of joints on the game character. In one embodiment, a display of the game sequence may be shown on the user's computer display device. In one embodiment, the game sequence may employ a first person perspective or camera position. That is, in one embodiment, the user may view actions of the game character from the perspective of the game character, in a perspective sometimes known as a first person “shooter” perspective.

Processing flows next to blocks 605 and/or 606 where the user may select to execute the game logic and game animation to enable a display on a computer display device a sequence of movements over a plurality of frames within the video game world. At block 605, in at least one embodiment, the executing of the game animation and game logic may generate game world component data from the game. Also, in at least one embodiment, the game world component data may be imported as a sequence, e.g., copied from game assets in a manner similar to applying animation presets.

In one embodiment, the user may employ the game recorder, described above, to record some or all of the game animation as animation motion capture by recording multi-dimensional video game world component data, including the one or more selected joints. That is, in one embodiment, while executing the movements during the video game sequence of the video game, the user records within each of the distinct plurality of different data logs multi-dimensional video game world data for the identified plurality of components prior to rendering each frame.

Block 606 may be entered concurrent with block 605, or subsequent to/or even before execution of the game sequence. Moreover, the user may select to stop recording concurrent with, or even before completing execution of the game sequence.

Processing then flows to block 608, where the user may terminate the game sequence and/or the recording of the multi-dimensional video game world component data. Processing continues next to block 610, where the user may play back the recorded game sequence using the recorded multi-dimensional video game world component data. That is, in one embodiment, the user may perform a jump to a specified frame within the recorded plurality of frames from within the recorded video game sequence stored within the plurality of distinct data logs. As used herein, jumping refers to a process of selecting and accessing a specified frame based on some identifier, such as a time, play sequence identifier, or the like. It should be noted, however, that the user is not limited to proceeding to block 610, and although not illustrated, the user may cycle through blocks 605 and/or 606 as often as desired, before selecting to play back the recorded game sequence. Moreover, the user may also loop back to block 602 and/or 604 to select different scenes, game characters, joints for recording, or the like, without departing from the scope of the invention.

In any event, at block 610, the user may then select one or more portions of the recorded game sequence for editing. That is, using a data log editor such as described above, the user may edit at least some of the recorded multi-dimensional video game world data within at least one of the distinct data logs within the plurality of data logs for a specified frame range.

When the game sequence (e.g., movie) is ready to be published and distributed, we save out an image sequence for the entire movie and an associated audio file to be played in sync in commonly found venues, such as on the internet, television, theatres, DVDs, or the like. At this point, the process steps through the movie, frame by frame, constructing the final frame using the logic found in display components 320 in FIG. 3, and then saves the screen output into a single image file, which may then be saved to, such as data stores 260 of FIG. 2, or other computer-readable storage medium.

The user may select any of a variety of editing mechanisms, including, but not limited to compositing the recorded game sequence with another game sequence and/or game characters, inserting a portion of a game sequence into the recorded game sequence, deleting portions of the recorded game sequence, and/or manipulating portions of the game sequence, for example, by modifying portions of a motion trail for a joint. A modification to one or more portions of the motion trail for the joint may include, but are not limited to, orientation, position, and rotation of the joint. As noted, however, the user is not limited to merely these manipulations, and others may also be performed, including modifying a camera perspective of the recorded game state data, for example. Thus, because the present invention is directed towards recording multi-dimensional video game world component data that includes that data used for calculating an image rather than the image itself, a plurality of different manipulations may be performed that might not otherwise be available by recording triggers and events from the triggers.

Proceeding to block 612, the user may then have the results of the edits sent to the material system within the network computing device the recorded multi-dimensional video game world data within each of the distinct data logs including the at some edited data within at least one of the distinct data logs to display a modified video game sequence for the specified frame range. As noted above, however, the results may also be fed back to the animation system for further updates to the multi-dimensional video game world component data. Flowing next to block 614, the output of the material system are further fed to a rendering component, to be rendered as an image displayable on a video device.

Process 600 may then flow to decision block 616, where a determination is made whether to continue recording and editing the multi-dimensional video game world component data. If so, then processing loops back to block 604 where the user may further select one or more joints for recording as multi-dimensional video game world component data. If process 600 is to be terminated, however, processing then may return to another process to perform other actions.

FIG. 7 is a block diagram of an animation development system 700 that may be employed with the present invention. Animation development system 700 employs various components described above in conjunction with FIG. 2. However, as shown animation development system 700 further illustrates additional subcomponents, for example, of GRE 251 of FIG. 2, to further illustrate use of the network device 200 for employing presets.

As shown in FIG. 3, animation development system 300 may include a development device 702 and an editing device 704. Each of these devices may be subcomponents of GRE 251 of FIG. 2, or separate components that may be called by GRE 251.

As illustrated, development device 702 may include one or more games 704 that may represent an interactive animated game that is played by one or more game players. The “Half-Life” series of games by Valve Corporation of Bellevue, Wash., are non-limiting, non-exhaustive examples of games that may be used with development device 702.

Development device 702 may also include recorder 706. Recorder 706 may include program code and data that captures and records data pertaining to a game, a scene, or a character from game 704, storing the data as recordings 708. Recordings 708 represent one embodiment of multi-dimensional video game world data as described above.

Preset extractor/editor 720 may include program code or data that is used to extract data from recordings 708, modify or enhance the data, and store the resultant animation presets 712. An animation preset may include data descriptive of one or more characters or portions thereof. A preset may represent an animation frame or a sequence of frames over a specified time interval. As used herein, the terms “preset,” “animation preset,” and “preset sample” are equivalent terms. One or more recordings 708 may be combined, subdivided, duplicated, or otherwise manipulated to produce one or more presets 712. For example, a developer may perform a scene of a game multiple times, such that each pass through the scene is captured and recorded as a recording 708. Multiple recordings corresponding to the same scene may be combined to produce a preset 712.

Editing device 704 may be used by an animator to create or edit animations or animation frames. In the illustrated embodiment, editing device 704 includes an animation editor 714, which may include program logic and data that enables the animator to perform editing actions. Animation editor 714 may receive as input one or more presets 712. As illustrated, animation editor 714 receives a preset 712 from development device 702. Presets may be directly received from development device 702, or they may be received from a storage device. The actions of animation editor 714, and the use of presets 712, are discussed in further detail below. Briefly, an animator may employ animation editor 714 to edit an animation by providing specifications to insert one or more presets 712 into animation 716. Animation editor 714 may provide an interface that enables an animator to select an animation preset and provide one or more specifications that indicate how and where to insert the preset into the animation 716. For example, one of the specifications may include a weight of the preset, which may then be used to weight the preset data when it is inserted into the animation. One specification may represent a portion of the preset to use, a portion of the animation to be replaced by the preset, or a mask indicating a portion of the animation to be excluded when inserting the preset. Other specifications may indicate a time interval of the animation in which the preset is to be inserted, a transition period, or other specifications relating to altering the preset or inserting the preset into the animation. Animation sequence 718 represents a sequence of the animation 716 after inserting an animation 712. This may include portions of the preset or portions of the animation, each of which may be altered during the process. Aspects of using presets to create or edit an animation are described in further detail herein.

As used herein, the term “artist” refers to a person who may perform actions of creating one or more characters or character behaviors. The term “developer” refers to a person who may perform actions of creating or editing one or more animation presets for use by an animator. The term “animator” refers to a person who may perform actions of generating or editing character behaviors, frames, or animations. The terms “artist,” “developer,” and “animator” are functional terms, however, and the corresponding tasks may be performed by a single person or distributed among multiple people in a variety of ways. Thus, use of these terms is not intended to limit the distribution of tasks among people with respect to the mechanisms herein described.

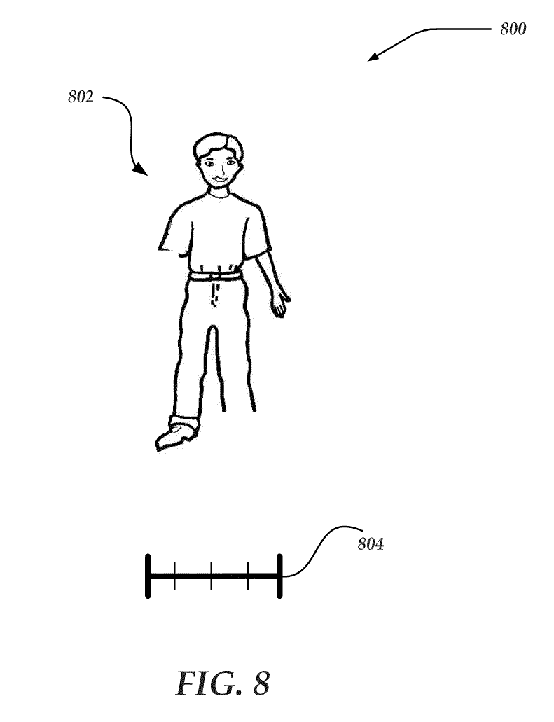

FIG. 8 illustrates an example of preset data 800 that may be used in accordance with an embodiment of the present invention. Preset data 800 may be an example of presets 812 of FIG. 7. In one embodiment, a developer may create preset data 800 by performing a segment of an animated game, while capturing and recording the performed segment as multi-dimensional video game world data. The developer may perform these actions one or more times and combine each captured segment representing a time interval into a single segment representing the same time interval. For example, while performing the game a first time, a first character may be captured and recorded. While performing the game a second time, a second character may be captured and recorded. Both characters may be combined into a single preset, such that the characters can both be seen in the preset.

The example preset data 800 illustrates a captured animation 802. Though only one frame of the captured image 802 is illustrated in FIG. 8, a captured animation may include multiple frames corresponding to an animation sequence. Time interval 804 represents an interval of time corresponding to the captured animation 802 in real time. Preset data 800 may include additional data not illustrated, such as audio data, multiple views of the captured animation, data relating to constraints of the preset data, how each character of the preset data interact with other characters of object, or the like. Also, as shown, the character is animated in such as way as to be missing both an arm below the elbow and a foot.

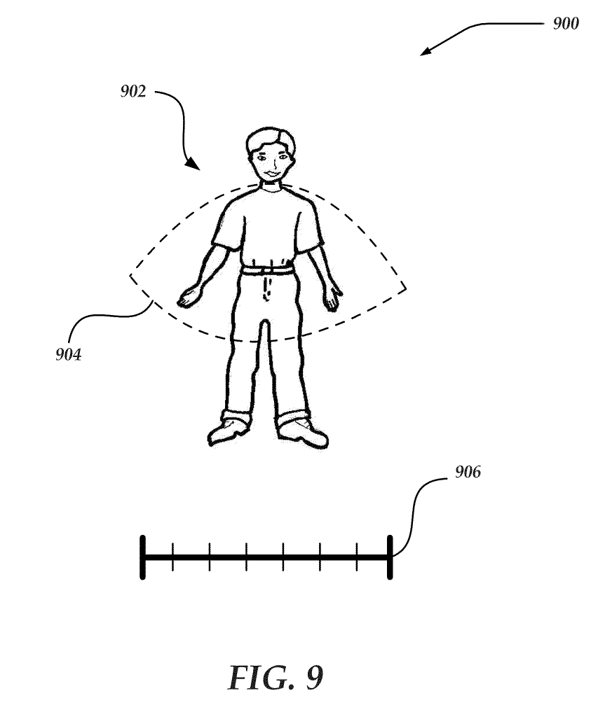

FIG. 9 illustrates an example of an animation segment 900 prior to insertion or merging of an animation preset. Animation segment 900 includes an animated character 902 that represents at least some of the multi-dimensional video game world data. Filter 904, indicated by dashed lines, represents a portion of the animation segment 900 to which a preset is to be applied. An animation editor may use an interface of an animation editor to specify one or more filters 904 corresponding to animation segment 900. The filter may delineate a target portion of a character or frame from a non-target portion of the character or frame. The filter may indicate a portion of a character, such as a hand, arm, face, leg, or a combination thereof. The filter may indicate a portion of the frame other than a character, into which a corresponding portion of the preset is to be inserted. For example, a second character may be inserted into animation segment 900 at a location designated by a specified filter. In one embodiment, an animation editor may specify a mask that indicates an area or a portion of a character that is not to be modified by a preset. For example, a mask may cover a character's face, indicating that a preset may modify the character except for the face. This has the effect of locking the body parts that are covered by the mask, preventing them from modification when a preset is inserted. A filter or mask may include one or more non-contiguous regions.

Time interval 906 represents an interval of time corresponding to the animation segment 900. In one embodiment, insertion of a preset into the animation is limited to the segment that spans time interval 906. In one implementation, if the time interval of a preset differs from the time interval of the target animation segment, the preset sequence is stretched or compressed to fit the latter time interval. Also, as shown, the character is animated in such a way that both arms and both feet are present.

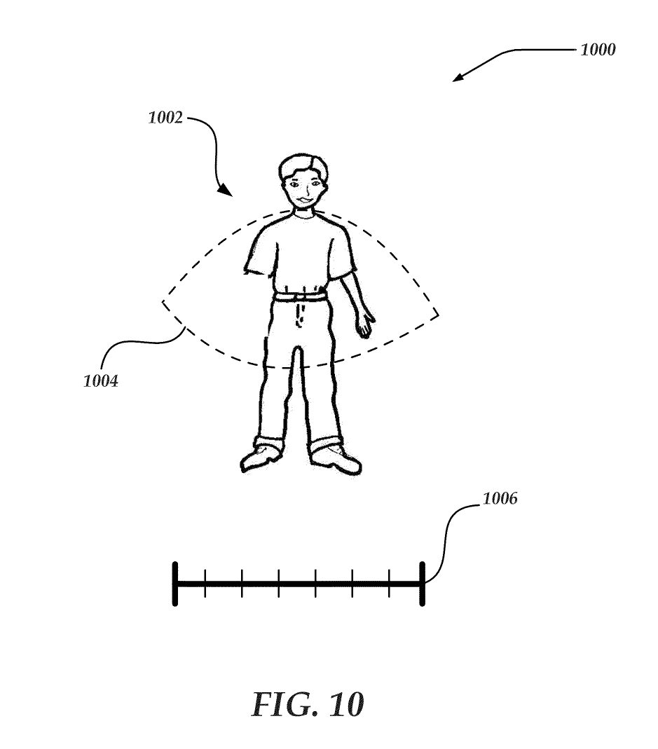

FIG. 10 illustrates an example of animation segment 1000 subsequent to insertion of preset data 800 into animation segment 900. Animation segment 1000 includes animated character 1002, which is an altered version of animated character 902. As illustrated in FIG. 10, the filter region 1004 includes animation data from preset data 800, while portions of animated character 1002 outside of the filter region 1004 remain unchanged. For example, the character is shown missing an arm below the elbow (animation from FIG. 8) but it includes both feet (animation from FIG. 9).

FIG. 10 illustrates one frame of an animation segment, though a segment may be made up of many frames. Though not illustrated, insertion of the preset data may be applied to each frame of the target animation sequence. More specifically, each frame of the target animation sequence may be altered by inserting a corresponding frame from the animation preset. In some configurations, there may be a one-to-one correspondence between the target animation sequence frames and the preset frames. In some configurations, some preset frames may be unused when inserting the preset into a target animation sequence. This may occur when a preset is “compacted” to match a smaller target interval. In some configurations, a preset frame may have multiple corresponding target animation frames. This may occur when a preset is “stretched” to match a target interval that is longer than the preset interval. In some configurations, multiple preset frames may be combined when inserting into a corresponding target animation frame, to accommodate a change of time interval. In the examples of FIGS. 8-10, the time interval 804 (FIG. 8) of the preset is shorter than the time interval 906 (FIG. 9), causing the preset to be stretched over the target interval.

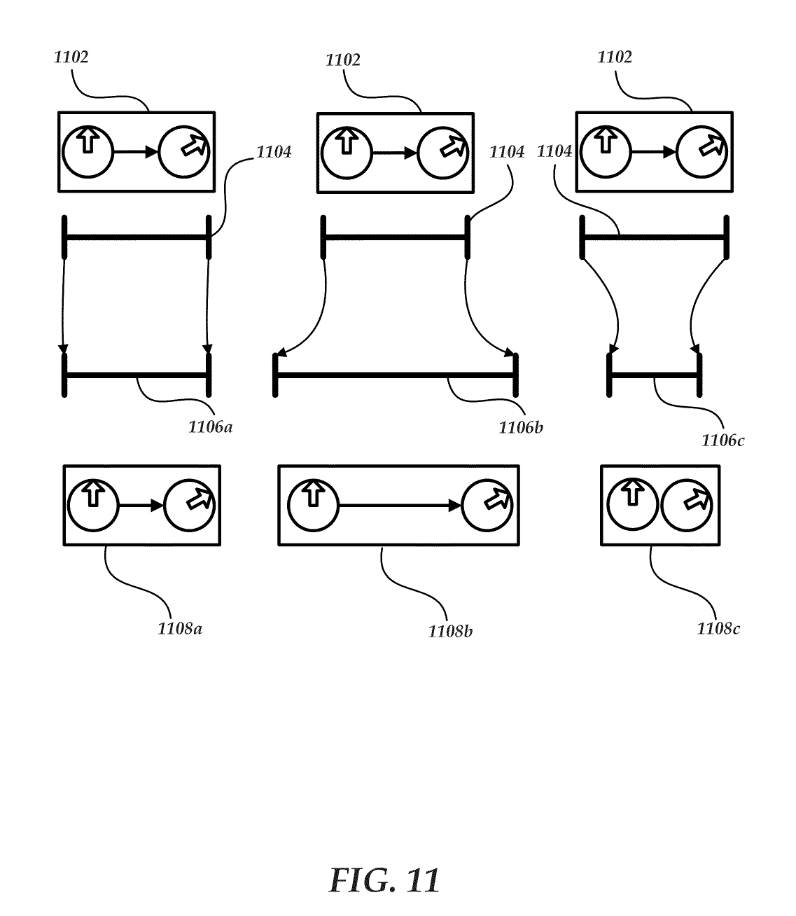

FIG. 11 illustrates a mechanism for inserting an animation preset into a target animation sequence, in which the time intervals corresponding to the preset and the target animation sequence may differ. Each of animation presets 1102 include two clocks indicating a time at the beginning and end of the animation sequence. Each clock within a preset sequence may, for example, represent a character in the first frame and last frame of the preset sequence. Thus each instance of preset 1102 is identical. Time interval 1102 represents the time interval of each animation preset. This may be time interval 804 of FIG. 8, or another time interval corresponding to another preset.

Time intervals 1106a-c correspond to three different target animation sequences. The magnitude of each time interval 1106a-c and time interval 1102 may represent “real time” or a number of frames in the corresponding animation sequence. Time interval 1106a has the same length of time as time interval 1102. In one embodiment, when a preset is inserted into an animation sequence having the same time interval as the preset, the time interval of the preset is unchanged. In the resulting animation sequence 1108a, the distance between the clocks, representing the time interval 1106a, are shown as unchanged from preset 1102.

Time interval 1106b indicates a longer time interval than time interval 1102. In one embodiment, the time interval 1102 corresponding to the preset is automatically stretched to fit the target time interval 1106b. In the resulting animation sequence 1108b, the distance between the clocks, representing the time interval 1106b, is expanded as compared with preset 1102. The clocks, representing the first and last frames of the preset, are unchanged, but they may appear to move slower than in the original preset animation.

Time interval 1106c indicates a shorter time interval than time interval 1102. In one embodiment, the time interval 1102 corresponding to the preset is automatically compressed to fit the target time interval 1106c. In the resulting animation sequence 1108c, the distance between the clocks, representing the time interval 1106c, is compressed as compared with preset 1102. The clocks, representing the first and last frames of the preset, are unchanged, but they may appear to move faster than in the original preset animation.

In one example use of presets, a preset may be created of an action that is to be repeated multiple times, with the motion differing in each iteration. This may be performed, for example, by selecting shorter and shorter target time intervals, and inserting the preset into each time interval. Each iteration will appear faster than the one prior to it. At each interval, a character may therefore appear to accelerate an action relative to the prior interval. Similarly, by selecting longer consecutive time intervals, each iteration will appear slower than the one prior to it, appearing to decelerate an action.

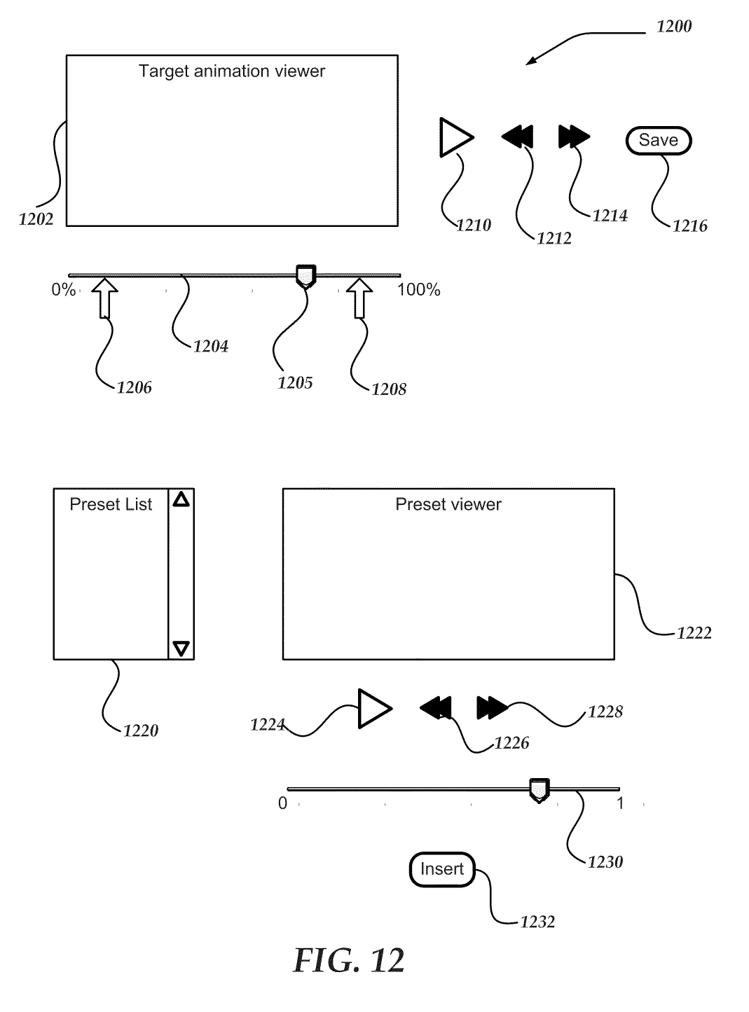

FIG. 12 is an example of an interface 1200 for editing an animation. An animator may employ interface 1200 to insert an animation preset into a target animation sequence. Interface 1200 may be implemented by animation editor 714 of FIG. 7 on animation editing device 704, or by another program component on the same or another device. It is to be understood that interface 1200 is one example of an interface, and one or more of numerous interfaces may be employed with the mechanisms described herein.

As illustrated in FIG. 12, interface 1200 may include a target animation viewer 1202, which may be a window in which a target animation sequence may be viewed. Target animation viewer 1202 may be used to select the target animation sequence as a portion of a larger animation, or another mechanism may be used. Target animation viewer 1202 may have corresponding controls, such as play/pause toggle 1210, forward frame step control 1214, or reverse frame step control 1212. These controls may be used to play the target animation segment, or single step frame by frame in a forward or reverse direction, respectively.

Target animation slider 1204 may indicate an interval of the target animation sequence, with position pointer 1205 indicating a current position relative to the beginning and ending of the sequence. Fade in control 1206 may be used to specify the length of the sub-segment into which the preset is to be faded in. Similarly, fade out control 1208 may be used to specify the length of the sub-segment into which the preset is to be faded out. Save button 1216 may be used to save the revised animation after the animator has inserted a preset. Though not illustrated, other controls may be employed to perform additional editing functions, access files, and execute other commands.

Preset list control 1220 may be used to select a preset from among a set of presets. This control may include a name for each preset, a scroll bar for scrolling through the list, and a mechanism for selecting a preset from among the available choices. Preset list control 1220 or an associated control may display additional information about each preset, such as its time interval or other data.

Preset viewer 1222 may be a window in which a selected animation preset may be viewed. Thus, in response to a selection of a preset by use of the preset list control 1220, the selected preset may be displayed within preset viewer 1222. Associated controls, such as play/pause toggle 1210, forward frame step 1228, or reverse frame step 1226 may be used to play the animation preset, or single step frame by frame in a forward or reverse direction, respectively.

Preset weight selector 1230 may be used to specify a weighting that is to be assigned to the preset when combining with the target animation sequence. In one implementation, a magnitude between zero and one may be selected, representing a weighting between zero and 100%. Though not illustrated, various other controls may be employed to edit or control a preset. Insert preset control 1232 may be used to instruct the editing program to perform the insertion of the preset into the target animation sequence.

An animator may interact with interface 1200 in a number of ways and in a variety of sequences. In one example sequence, an animator may use target animation sequence viewer 1202 to select and view a target animation sequence as a portion of a greater animation. Fade in control 1206 and fade out control 1208 may be used to specify time intervals for fading in and fading out a preset. A desired preset may be selected by use of preset list control 1220. The preset may then be viewed in preset viewer 1222. A preset weight may be specified by use of preset weight control 1230. In response to a selection of the insert preset control 1232, the selected preset may be inserted into the target animation sequence, selectively modifying portions of the target animation sequence. Play/pause control 1210, forward frame step control 1214, and reverse frame step control 1212 may be used to view the altered target animation sequence. If it is acceptable, the save control 1216 may be used to store the altered target animation sequence.

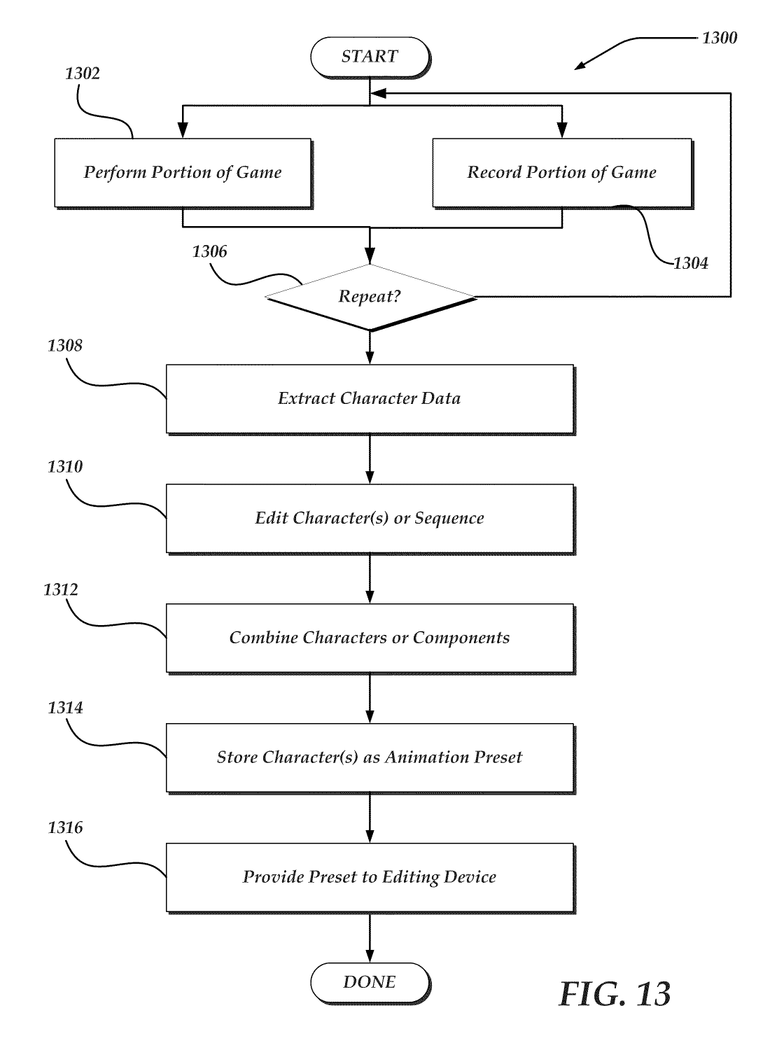

FIG. 13 is a flow diagram illustrating a process 1300 of generating an animation preset in accordance with an embodiment of the present invention. Process 1300 may employ the development device 702 of FIG. 7, or another computing device. In one embodiment, a developer may initiate or control process 1300. As illustrated in FIG. 13, the process 1300 begins, after a begin block, at blocks 1302 and 1304. At block 1302, a portion of an animated game may be performed. Though not illustrated, various initialization actions may be performed prior to, or in conjunction with, block 1302. Initialization actions may include initiating selection of the game, creation of one or more characters or game components, navigation to a desired scene, executing a command to indicate preset recording, or the like. At block 1302, a portion of the game may be performed. Performance of the game may include interaction by a developer. It may also include interaction by one or more other game players, who may be located locally or remotely. In some configurations, interaction by a developer or other players may not be required while performing the game portion.

In one embodiment, actions of block 1304 may be performed at least partially concurrently with actions of block 1302. At block 1304, one or more characters of the game portion, or the entire game portion, may be recorded. Recording a portion of the game may include storing one or more of a number of types of information descriptive of the game portion. It may include storing one or more views, such as a view that a character sees or a view of the character from one or more viewpoints. It may include storing one or more audio tracks, data descriptive of a character's positions or movement, timing data, or the like.

Process 1300 may flow to decision block 1306, where a determination is made of whether to repeat the actions of blocks 1302 and 1304. A developer may execute commands or take other actions to perform a portion of the game. This portion may be the same portion as previously performed, a different portion, or an overlapping portion. During the second iteration of block 1302, a developer may employ the game to control a different character, introduce an additional character, or control the same character in a different manner than during the first iteration of block 1302. At block 1304, the performance of the game portion is recorded. This may include recording a different view or other different data of a character that was previously recorded during a prior iteration.

Blocks 1302 and 1304 may be repeated multiple times, based on commands by a developer. As illustrated in FIG. 7, this may result in one or more recordings 708 produced by recorder 706. After a first or later iteration, the process may flow to block 1308. At block 1308, one or more characters or other animation components may be extracted from the recordings. At block 1310, the extracted character(s) or other components may be edited. In one implementation, a developer may employ a preset editor to alter one or more extracted characters or components, or to alter the captured animation sequence. For example, the time interval of the sequence may be increased or decreased, or portions of the sequence may be deleted or moved. An editor may be used to alter features of a character as desired by a developer.

Process 1300 may flow to block 1312, where one or more characters or components that have been recorded may be combined to form a unified animation sequence. This action, or a portion of this action, may be performed at other times during process 1300, such as prior to block 1310, prior to block 1308, or during the recording of each iteration, at block 1304.

The process may flow to block 1314, where the characters or components are stored as one or more animation presets 712 (FIG. 7). In one implementation, process 1300 may flow to block 1316, where one or more of the presets may be provided to an editing device 704 to be applied in creating or editing an animation. The process may flow to a done block, and return to a calling program.

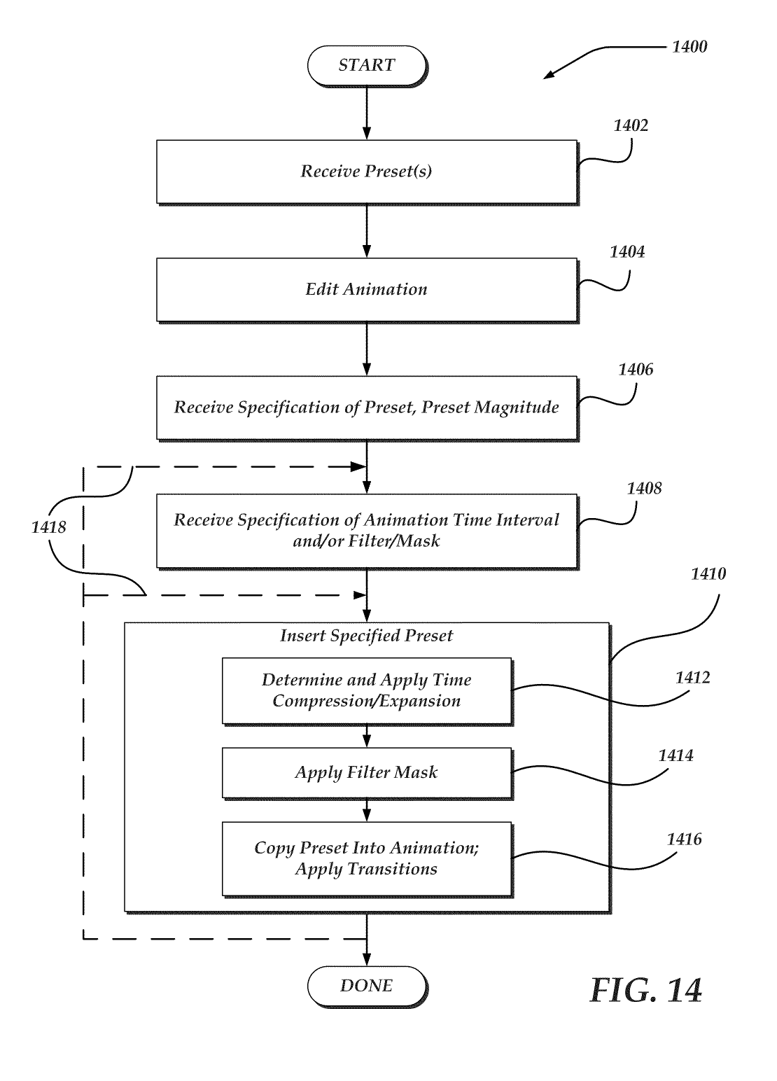

FIG. 14 is a flow diagram of a process 1400 of applying a preset to an animation in accordance with an embodiment of the invention. Process 1400 may employ the editing device 704 of FIG. 7, or another computing device. In one embodiment, an animator may initiate or control process 1400. As illustrated in FIG. 14, the process 1000 begins, after a begin block, at block 1402, where one or more animation presets may be received. In one configuration, an animation preset may be received from a development device, a server, or another computing device. In one configuration, the preset may be received from storage within the same computing device, or from other storage.

Process 1400 may flow to block 1404, where an animation may be edited. This may be performed by an animation editor or other program, and may be under the control of an animator or other user. In one configuration, editing an animation at block 1404 may include creating a new animation or a new segment of an existing animation. Editing an animation may include performing various alterations or providing one or more specifications to an existing animation.

Process 1400 may flow to block 1406, where a specification of a preset to be inserted into the animation is received. In one implementation, an animation editor may provide an animator with a choice of one or more presets, and the animator may use the animation editor interface to specify a preset from among the choices. In one implementation, the animation editor may provide an interface that assists a selection, such as by filtering the presets based on one or more criteria, viewing each of the choices, or other interface mechanisms. In one implementation, a specification of a preset at block 1406 may be performed prior to receiving the specified preset at block 1402. For example, after specifying a preset, the specified preset may be retrieved from a local or remote storage device.

The actions of block 1406 may include receiving a specification of a magnitude or weight of the selected preset. In one implementation, an animation editor may provide a magnitude specification mechanism, such as a slider, that enables an animator to specify a magnitude. The specified magnitude may subsequently be used as a weight when combining the preset with the animation.

Process 1400 may flow to block 1408, where a specification of a time interval of the animation may be received, or a specification of a filter corresponding to the animation may be received. Specifications of a time interval may include a start position relative to the beginning of the animation or another position, and a length of the time interval. The length of the interval may be specified in units of time, animation frames, or another metric. The length of the interval may be specified by specifying an end position relative to the beginning of the animation or another position, or by specifying an animation frame that terminates the interval. In one implementation, the length of the selected preset may be used as a default time interval if one is not explicitly specified.

In one implementation, an animation editor may enable an animator to indirectly specify the time interval of the target animation sequence by specifying a time interval of the preset or by specifying an amount of compression or stretching of the preset. For example, a preset may have a time interval of N seconds, and an animator may specify that it is to be compressed or expanded into M seconds, where M is less than N for compression and M is greater than N for stretching. In another implementation, an animator may specify that the preset is to be compressed by a selected amount, or to be stretched by a selected amount. From these specifications, the corresponding time interval of the target animation sequence may be determined.

Compressing or stretching an animation preset may be performed in a variety of ways. In one implementation, compressing an animation preset includes removing one or more frames in order to reduce the total number of frames. In one implementation, compressing an animation preset includes merging two or more frames into a single frame. In one implementation, stretching an animation preset may include duplicating one or more frames in order to increase the total number of frames. In one implementation, stretching an animation preset may include combining two frames to generate a third frame, thereby increasing the total number of frames. Other techniques may also be used to compress or stretch an animation preset.

The actions of block 1408 may include specifying a filter or mask to be used when combining the selected preset with the animation. As discussed herein, a filter may indicate a portion of the animation frames, such as a portion of a character, into which a corresponding portion of the preset is to be inserted. A mask may indicate an area or portion of a character that is not to be modified by the preset, while the areas outside of the mask are modified.

Process 1000 may flow to block 1410, where the selected preset is inserted into the animation. Inserting the preset may include one or more actions. FIG. 14 illustrates three sub-blocks of block 1410, specifically blocks 1412-1416 representing actions that may be performed to insert the selected animation. At sub-block 1412, time compression or expansion of the preset is determined and applied. Time compression may be determined by comparing the time interval of the preset with the time interval of the specified target animation sequence. A longer preset interval may indicate compression, and the ratio of the time intervals may indicate an amount of the compression. A shorter preset interval may indicate expansion, and the ratio of the time intervals may indicate an amount of the expansion. If the time intervals match, the time interval of the preset may be unchanged. The determined amount of compression or expansion may be used when inserting the preset.

At sub-block 1414, a filter or mask is selectively applied, based on whether one has been specified. This may include delineating the components of the target animation sequence into which the preset is to be inserted, or delineating the components into which the preset is to be excluded.

At sub-block 1416, the preset may be copied into the animation. This may include a transition into the animation at the beginning of the animation sequence or a transition out of the animation at the end of the sequence. One of a variety of transition techniques may be employed, such as cross-fading the preset with the target animation sequence. As discussed above, copying may include compression or expansion of the preset, or applying a mask or filter.

As indicated by dashed lines 1418, block 1410, or blocks 1408 and 1010 may be repeated one or more times under the control of an animator. Thus, an animator may create repetitive animated sequences, and optionally modify the time interval specifications on one or more of the repeated sequences. As discussed herein, this may be performed to create repeated animated actions that are accelerated or decelerated over the multiple intervals.

Process 1400 may flow to a done block, where processing may return to a calling program, or repeat the process or a portion thereof.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method device for editing video game world data with animation presets with a network computing device, the method enabling actions comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames for editing of it's corresponding video game world data for at least one identified component; and
editing the corresponding video game world data by performing actions, including:
receiving an animation preset that includes a predetermined sub-sequence of video game frames; and
copying at least a portion of the animation preset into at least a portion of the video game world data, wherein the video game world data is subsequently stored; and
providing the edited video game world data to a material system prior to a subsequent display of a modified sequence of animation that corresponds to the edited video game world data for at least the selected portion of the video game frames.

2. The method of claim 1, wherein the sub-sequence includes a target character, and wherein copying comprises replacing a portion of the target character with the portion of the animation preset.

3. The method of claim 1, wherein a time length of the animation preset is different from a time period of the sub-sequence, and wherein copying further comprises at least one of cropping, extending, compressing and stretching the animation preset to fit the time period of the sub-sequence.

4. The method of claim 1, wherein the animation preset is at least one of an anchored animation preset and a non-anchored animation preset.

5. The method of claim 1, wherein the animation preset further comprises a sequence of video game world frames recorded during a previous play of a video game world.

6. The method of claim 1, wherein the animation preset further comprises a segment of dynamic video game world data corresponding to a video game character.

7. The method of claim 1, further comprising receiving at least one of a filter and a mask delineating a portion of at least one video game frame, and wherein the at least a portion of the animation preset is based on the at least one of a filter and a mask.

8. A network device for editing video game world data with animation presets, comprising:
a memory configured to store data;
an interface for a user;
a processor that is operative to execute data that enables actions to be performed, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames for editing of it's corresponding video game world data for at least one identified component; and
editing the corresponding video game world data by performing actions, including:
receiving an animation preset that includes a predetermined sub-sequence of video game frames; and
copying at least a portion of the animation preset into at least a portion of the video game world data, wherein the video game world data is subsequently stored; and
providing the edited video game world data to a material system prior to a subsequent display of a modified sequence of animation that corresponds to the edited video game world data for at least the selected portion of the video game frames.

9. The device of claim 8, wherein the sub-sequence includes a target character, and wherein copying comprises replacing a portion of the target character with the portion of the animation preset.

10. The device of claim 8, wherein a time length of the animation preset is different from a time period of the sub-sequence, and wherein copying further comprises at least one of cropping, extending, compressing and stretching the animation preset to fit the time period of the sub-sequence.

11. The device of claim 8, wherein the animation preset is at least one of an anchored animation preset and a non-anchored animation preset.

12. The device of claim 8, wherein the animation preset further comprises a sequence of video game world frames recorded during a previous play of a video game world.

13. The device of claim 8, wherein the animation preset further comprises a segment of dynamic video game world data corresponding to a video game character.

14. The device of claim 8, further comprising receiving at least one of a filter and a mask delineating a portion of at least one video game frame, and wherein the at least a portion of the animation preset is based on the at least one of a filter and a mask.

15. A processor readable non-transitory storage medium that includes data and instructions for editing video game world data, wherein the execution of the instructions by a processor enables actions, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames for editing of it's corresponding video game world data for at least one identified component; and
editing the corresponding video game world data by performing actions, including:
receiving an animation preset that includes a predetermined sub-sequence of video game frames; and
copying at least a portion of the animation preset into at least a portion of the video game world data, wherein the video game world data is subsequently stored; and
providing the edited video game world data to a material system prior to a subsequent display of a modified sequence of animation that corresponds to the edited video game world data for at least the selected portion of the video game frames.

16. The medium of claim 15, wherein the sub-sequence includes a target character, and wherein copying comprises replacing a portion of the target character with the portion of the animation preset.

17. The medium of claim 15, wherein a time length of the animation preset is different from a time period of the sub-sequence, and wherein copying further comprises at least one of cropping, extending, compressing and stretching the animation preset to fit the time period of the sub-sequence.

18. The medium of claim 15, wherein the animation preset is at least one of an anchored animation preset and a non-anchored animation preset.

19. The medium of claim 15, wherein the animation preset further comprises a sequence of video game world frames recorded during a previous play of a video game world.

20. The medium of claim 15, wherein the animation preset further comprises a segment of dynamic video game world data corresponding to a video game character.

21. The medium of claim 15, further comprising receiving at least one of a filter and a mask delineating a portion of at least one video game frame, and wherein the at least a portion of the animation preset is based on the at least one of a filter and a mask.

22. A system for editing video game world data with animation presets, comprising:
a first network device, including:
a first memory configured to store data;
a first display device;
a first processor that is operative to execute data that enables actions to be performed, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames for editing of it's corresponding video game world data for at least one identified component; and
editing the corresponding video game world data by performing actions, including:
receiving an animation preset that includes a predetermined sub-sequence of video game frames; and
copying at least a portion of the animation preset into at least a portion of the video game world data, wherein the video game world data is subsequently stored; and
providing the edited video game world data to a material system prior to a subsequent display of a modified sequence of animation that corresponds to the edited video game world data for at least the selected portion of the video game frames; and
a second network device, including:
a second memory configured to store data;
a second display device for displaying at last an interface to a user;
a second processor that is operative to execute data that enables actions to be performed, comprising:
executing the video game world based at least in part on the stored video game world data; and
rendering and displaying the modified sequence of animation within at least a portion of the video game world that is played by the user.

23. The system of claim 22, wherein the sub-sequence includes a target character, and wherein copying comprises replacing a portion of the target character with the portion of the animation preset.

24. The system of claim 22, wherein a time length of the animation preset is different from a time period of the sub-sequence, and wherein copying further comprises at least one of cropping, extending, compressing and stretching the animation preset to fit the time period of the sub-sequence.

25. The system of claim 22, wherein the animation preset is at least one of an anchored animation preset and a non-anchored animation preset.

26. The system of claim 22, wherein the animation preset further comprises a sequence of video game world frames recorded during a previous play of a video game world.

27. The system of claim 22, wherein the animation preset further comprises a segment of dynamic video game world data corresponding to a video game character.

28. The system of claim 22, further comprising receiving at least one of a filter and a mask delineating a portion of at least one video game frame, and wherein the at least a portion of the animation preset is based on the at least one of a filter and a mask.
